(19) United States
(12) Patent Application Publication
(10) Pub. No.: US 2025/0372321 A1
(43) Pub. Date: Dec. 4, 2025

(54) KEY TRAVEL-ADJUSTABLE SWITCH AND GAMING PERIPHERAL

(71) Applicant: QANBA USA, LLC, Daly City, CA (US)

(72) Inventors: Kai LIU, Daly City, CA (US); Jeffrey LYO, Daly City, CA (US)

(21) Appl. No.: 18/883,104

(22) Filed: Sep. 12, 2024

(30) Foreign Application Priority Data
May 30, 2024 (CN) 2024106843974

(51) Int. Cl. H01H 13/18; A63F 13/24

(52) U.S. Cl. CPC H01H 13/18; A63F 13/24

(57) ABSTRACT

The present disclosure discloses a key travel adjustable switch. The key travel adjustable switch includes a travel adjusting member, a travel positioning member and a micro switch. The travel adjusting member is removably mounted to the travel positioning member. The travel positioning member is provided with a plurality of travel positions. The travel adjusting member has at least one travel adjusting portion clamped to a travel position of the plurality of the travel positions in an initial state. The travel adjusting member is triggered to move by a corresponding adjustable key travel according to a corresponding travel position that the at least one travel adjusting portion is positioned at to trigger the micro switch. Each of corresponding key travels is different from the others. The key travel adjustable switch of the present disclosure is capable of adjusting the key travel of the key travel adjustable switch, thereby adjusting a response speed of the key travel adjustable switch.

### CROSS-REFERENCE TO RELATED APPLICATION(S)

The present application claims priority to and the benefit of Chinese Patent Application No. 2024106843974, filed on May 30, 2024, in China National Intellectual Property Administration, the entire disclosure of which is incorporated herein by reference.

### TECHNICAL FIELD

The present disclosure relates to the field of a switch and a gaming peripheral including the switch, and in particular to a key travel adjustable switch.

### BACKGROUND

Currently, in the field of gaming peripherals, a key travel to trigger an action of a switch of a gaming product is single and fixed in most cases. It is complicated to use a switch that can have its trigger travel to trigger an action adjusted by a software driver (e.g., a computer software). Furthermore, a physical key travel of such switch does not change with the adjusted trigger travel to trigger the action. As a result, a user does not have a direct feeling (e.g., game feel) in response to such adjustment.

In addition, with the development of e-sports games, different users have higher requirements for a game switch. Specifically, different users have different needs for a press feeling or a response speed of the game switch. However, the current switch having a single key travel to trigger the action cannot meet the needs of different users.

### SUMMARY

The present disclosure aims to provide a key travel adjustable switch in order to solve the above problems.

The present disclosure achieves the above purposes by means of the following technical solutions.

In the first aspect, the present disclosure provides a key travel adjustable switch, including a micro switch, a travel positioning member having a plurality of travel positions providing a plurality of key travels, and a travel adjusting member removably mounted to the travel positioning member. The travel adjusting member may have at least one travel adjusting portion connected to a first travel position of the plurality of travel positions, and the travel adjusting member may be triggered to move by a first key travel to trigger the micro switch, and the first key travel is determined based on the first travel position that the at least one travel adjusting portion is positioned at, and each of the plurality of key travels is different from the others.

In one or more embodiments, the key travel adjustable switch may be a keyboard key, a gamepad switch, or an arcade game switch.

In one or more embodiments, a number of the plurality of travel positions may be from 2 to 10.

In one or more embodiments, the key travel may range from 0.1 mm to 3 mm.

In one or more embodiments, the travel adjusting member may be a switch cap, the travel positioning member may be a switch body, and the key travel may be adjustable by rotating the at least one travel adjusting portion of the switch cap to the different travel positions of the switch body.

In one or more embodiments, the travel adjusting member may be a switch cap, the travel positioning member may be a rotary ring, and the key travel may be adjustable by rotating the rotary ring to move the at least one travel adjusting portion to the different travel positions of the rotary ring.

In one or more embodiments, the switch cap may be detachably connected to the switch body, and the key travel may be adjustable by detaching the switch cap from the switch body, adjusting a direction of the at least one travel adjusting portions of the switch cap, and inserting the switch cap into the switch body.

In one or more embodiments, the key travel adjustable switch may further include a silicone member, a snap fastener, and a micro switch pin member. The switch cap may be clamped to the snap fastener, the silicone member may be provided between a body of the switch cap and the snap fastener, and the silicone member may be positioned to connect to the switch cap. The snap fastener is rotationally connected to the micro switch pin member, and the switch cap, the silicone member and the snap fastener may form a rotational assembly. The key travel of the key travel adjustable switch may be adjustable by fitting the at least one travel adjusting portion at the different travel positions, which may be rendered by pressing and rotating the switch cap to fit the at least one travel adjusting portion with the plurality of travel positions on the switch body.

In one or more embodiments, the key travel adjustable switch may further include silicone member, a micro switch pin member, and a switch body. The switch cap may be clamped to the micro switch pin member, the silicone member may be provided between the switch cap and the micro switch pin member, and the rotary ring may be clamped to the switch body and may be rotated relatively to the switch body. A lower edge of the rotary ring may be provided with a plurality of travel adjusting portions of different heights, and the travel adjusting portions provided on the switch cap may be fitted with the plurality of travel positions. The key travel of the key travel adjustable switch may be adjustable by fitting the at least one travel adjusting portion at the different travel positions via rotating the rotary ring.

In the second aspect, the present disclosure provides a gaming peripheral, including the key travel adjustable switch described in the first aspect.

In the third aspect, the present disclosure provides a method for adjusting the key travel adjustable switch described in the first aspect. The method may include positioning the at least one travel adjusting portion at a first travel position of the plurality of travel positions, moving the travel adjusting member by a first key travel to trigger the micro switch, where the first key travel is determined based on the first travel position that the at least one travel adjusting portion is positioned at, and moving the at least one travel adjusting portion to a second travel position of the plurality of travel positions to adjust the first key travel to a second key travel, where each of the plurality of key travels is different from the others.

The present disclosure provides beneficial effects that an adjustable key travel (e.g., a physical key travel) of the switch to trigger an action can be adjusted, so as to adjust a response speed of the switch, thereby being capable of meeting different requirements for different users.

### BRIEF DESCRIPTION OF FIGURES

To describe the technical solutions in embodiments of the present disclosure or the prior art more clearly, the following briefly describes the accompanying drawings required for describing the embodiments or the prior art. Apparently, the accompanying drawings in the following description show only some embodiments of the present disclosure, and a person of ordinary skill in the art may still derive other accompanying drawings from the accompanying drawings without creative efforts.

FIG. 1 is a front view of Embodiment I of a switch of the present disclosure;

FIG. 2 is an A-A cross-sectional view of FIG. 1;

FIG. 3 is an axonometric view of FIG. 1;

FIG. 4 is an exploded view of Embodiment I of the switch of the present disclosure;

FIG. 5 is a structural view of a snap fastener and a micro switch pin member of the present disclosure;

FIG. 6 is a front view of a switch cap, the snap fastener, and the micro switch pin member of the present disclosure;

FIG. 7 is an axonometric view of FIG. 6;

FIG. 8 is a three-dimensional view of a silicone member in Embodiment I of the present disclosure;

FIG. 9 is a front view of Embodiment II of a switch of the present disclosure;

FIG. 10 is an A-A cross-sectional view of FIG. 9;

FIG. 11 is an axonometric view of FIG. 9;

FIG. 12 is a structural view of a switch cap, a rotary ring, and a micro switch pin member of the present disclosure;

FIG. 13 is a three-dimensional view of the rotary ring of the present disclosure;

FIG. 14 is a three-dimensional view of the silicone member in Embodiment II of the present disclosure;

FIG. 15 is an exploded view of Embodiment II of the present disclosure;

FIG. 16 is a left view of a switch body of the present disclosure;

FIG. 17 is an axonometric view of FIG. 16;

FIG. 18 is a front view of Embodiment III of a switch of the present disclosure;

FIG. 19 is an A-A cross-sectional view of FIG. 18;

FIG. 20 is an axonometric view of FIG. 18;

FIG. 21 is an exploded view of Embodiment III of the present disclosure;

FIG. 22 is a front view of a switch cap of the present disclosure;

FIG. 23 is an axonometric view of FIG. 22;

FIG. 24 is a front view of a snap fastener of the present disclosure; and

FIG. 25 is an axonometric view of FIG. 24.

### LIST OF REFERENCE NUMERALS

1: switch cap; 101: a body of the switch cap; 102: clamping board; 103: travel adjusting portion; 104: positioning groove; 105: side plate; 106: clamping hole; 2: silicone member; 201: compressing portion; 202: positioning protrusion; 3: switch body; 301: travel position; 302: avoiding groove; 303: clamping bump; 304: supporting step; 4: snap fastener; 401: clamping bump; 402: rotating limiting groove; 403: positioning bump; 5: micro switch pin member; 501: clamping pin; 502: limiting protrusion; 6: silicone pad; 7: micro switch; 8: rotary ring; 9: gear position or gear indicator; 111: side limiting plate; 112: position adjusting hole; 113: travel positioning edge.

### DETAILED DESCRIPTION

To make the objectives, technical solutions, and advantages of the present disclosure clearer, the following describes the technical solutions of the present disclosure in detail. The embodiments described are only some examples that form a part of the embodiments of the present disclosure, rather than all of the embodiments. All other embodiments obtained by a person of ordinary skill in the art based on the embodiments in the present disclosure without creative efforts shall fall within the protection scope of the present disclosure.

A switch of the present disclosure may include a travel adjusting member, a travel positioning member, and a micro switch. As used herein, the term “switch” may be a key or a switch that is actuated/triggered to change its state. A switch actuation of the switch may be occurred by any suitable physical interaction with the switch which may cause a mechanical linkage inside the switch to come into, or go out of, contact. For example, a physical interaction may be pushing, sliding, rotating, pulling, heating, and/or magnetizing. In one or more embodiments, the switch may be a magnetic switch, a capacitive switch, and a hall effect switch. In one or more embodiments, the switch may be a momentary push-down switch. The travel positioning member may be provided with a plurality of travel positions, and the travel adjusting member may have at least one travel adjusting portion that are connected to a travel position of the plurality of travel positions in an initial state. In one or more embodiments, a travel adjusting portion may be clamped to one travel position among the plurality of travel positions, which allows the adjusting member to be removably mounted to the travel positioning member. The travel adjusting member may be triggered to move by a corresponding adjustable key travel according to a corresponding travel position that the travel adjusting portion is positioned at to trigger the micro switch. Furthermore, the travel adjusting portion of the travel adjusting member may be moved to different travel positions of the travel positioning member, therefore, the corresponding adjustable key travel may be adjusted based on a corresponding travel position where the travel adjusting portion is located at. In one or more embodiments, each of corresponding adjustable key travels may be different from the others.

The switch of the present disclosure may be a keyboard key, a gamepad switch, or an arcade game switch. The key travel of the switch of the present disclosure may be adjustable when in use. For example, the key travel to trigger an action/switch a state of the switch may be adjusted. The key travel may be a distance that a switch cap (e.g., the travel adjusting member) of the switch is moved from where when the switch is pressed to where when the switch is responded to (e.g., from where when the switch is triggered to where when the switch is moved by a corresponding key travel), and specifically, the key travel may be a distance that the switch cap is moved from where when the switch cap is pressed to where when the micro switch is triggered (e.g., the switch is moved by a corresponding key travel to trigger the micro switch).

In one or more embodiments, the adjustable key travel may be adjustable by rotating the switch cap to fit the travel adjusting portion to different travel positions of a switch body (e.g., travel positioning member). In such embodiment, the different travel positions may be provided on the switch body, and by rotating the switch cap, the travel adjusting portion of the switch cap may be rotated to the different travel positions on the switch body.

In one or more embodiments, the key travel may be adjustable by rotating a ring (e.g., a rotating or rotatable ring) to relatively rotate the switch cap to different travel positions on the rotary ring. In such embodiment, the different travel positions may be provided on the rotary ring, and by rotating the rotary ring, the travel adjusting portion of the switch cap may be relatively rotated to the different travel positions on the rotary ring.

In one or more embodiments, the switch cap may be manually detached, and the switch cap may be mounted at different travel positions for adjusting the adjustable key travel of the switch. In such embodiment, the different travel positions may be provided on the switch body, and by removing the switch cap, a direction of the travel adjusting portion of the switch cap may be adjusted, so that the travel adjusting portion of the switch cap is mounted to the different travel positions on the switch body.

In one or more embodiments, a number of the travel positions may be plural. In one or more embodiments, the number of the travel positions may be from 2 to 10. For example, the number of the travel positions may be 2, 3, 4, 5, 6, 7, 8, 9, 10, or any suitable number to be included in the travel positioning member. The number of the travel positions may be specifically determined based on needs of a user. It may be understood that distances from different travel positions to the micro switch in the present disclosure may be different.

In one or more embodiments, an adjustable key travel of the switch may range from 0.1 mm to 3 mm (e.g., a distance that the travel position is moved downward). In one embodiment, the adjustable key travel may range from 0.5 mm to 1.5 mm. In yet another embodiment, the adjustable key travel may range from 0.8 mm to 1.2 mm. In other words, the travel positions may be providing the adjustable key travel ranging from 0.1 mm to 3 mm, from 0.5 mm to 1.5 mm, or from 0.8 mm to 1.2 mm.

For example, the travel positioning member may have three travel positions providing the adjustable key travel ranging from 0.8 mm to 1.2 mm, which may include a first travel position providing a first key travel of 0.8 mm, a second travel position providing a second key travel of 1.0 mm, and a third travel position providing a third key travel of 1.2 mm. In this case, when the user adjusts the travel adjusting portion of the switch cap to the first travel position providing the first key travel of 0.8 mm, by triggering the switch cap, the travel adjusting portion of the switch cap may be in contact with and trigger the micro switch when the switch cap is moved by the first key travel of 0.8 mm, which in turn may cause the switch to be responded to. When the user adjusts the travel adjusting portion of the switch cap to the second travel position providing the second key travel of 1.0 mm, by triggering the switch cap, the travel adjusting portion of the switch cap may be in contact with and trigger the micro switch when the switch cap is moved by the second key travel of 1.0 mm, which in turn may cause the switch to be responded to. When the user adjusts the travel adjusting portion of the switch cap to the third travel position providing the third key travel of 1.2 mm, by triggering the switch cap, the travel adjusting portion of the switch cap may be in contact with and trigger the micro switch when the switch cap is moved by the third key travel of 1.2 mm, which in turn causes the switch to be responded to.

In one or more embodiments, the travel adjusting member may be a switch cap, the travel positioning member may be a switch body, and by rotating the travel adjusting portion of the switch cap to different travel positions of the switch body, the adjustable key travel may be adjustable.

In one or more embodiments, the travel adjusting member may be a switch cap, the travel positioning member may be a rotary ring (e.g., an edge in a shape of a hat brim, or an annular shape), and by rotating the rotary ring, the travel adjusting portion may be shifted to different travel positions of the rotary ring, so that the adjustable key travel may be adjustable.

In one or more embodiments, the switch cap may be detachably connected to the switch body. By detaching the switch cap from the switch body, the switch cap may be inserted into the switch body after adjusting a direction of the travel adjusting portions of the switch cap, so that the adjustable key travel may be adjustable.

In one or more embodiments, the switch may further include a silicone member, a snap fastener, and a micro switch pin member, where the switch cap is clamped to the snap fastener, the silicone member may be provided between a body of the switch cap and the snap fastener. The silicone member may be positioned to connect to the switch cap. The snap fastener may be rotationally connected to the micro switch pin member. The switch cap, the silicone member, and the snap fastener may form a rotating assembly, and the switch cap may fit the plurality of travel positions on the switch body by means of the travel adjusting portion. By pressing and rotating the switch cap, the travel adjusting portion may fit different travel positions to adjust the adjustable key travel.

In one or more embodiments, the switch may further include a silicone member, a micro switch pin member, and a switch body. The switch cap may be clamped to the micro switch pin member, the silicone member may be provided between the switch cap and the micro switch pin member, and the rotary ring may be clamped to the switch body and may be able to rotate relative to the switch body. A lower edge of the rotary ring may be provided with the plurality of travel adjusting portions of different heights, and the travel adjusting portion may fit the travel adjusting portions provided on the switch cap. By rotating the rotary ring, the travel adjusting portion may be fitted to different travel positions to adjust the adjustable key travel.

The present disclosure further provides a gaming peripheral, and the gaming peripheral includes the switch described above.

The present disclosure further provides a method for adjusting the switch described above. The method may include positioning the at least one travel adjusting portion at a first travel position of the plurality of travel positions, moving the travel adjusting member by a first key travel to trigger the micro switch, where the first key travel is determined based on the first travel position that the at least one travel adjusting portion is positioned at, and moving the at least one travel adjusting portion to a second travel position of the plurality of travel positions to adjust the first key travel to a second key travel, wherein each of the plurality of key travels is different from the others.

Various embodiments of the present disclosure will be described in detail below with reference to the accompanying drawings of the description. In one or more embodiments below, the switch may also be referred to as a switch having an adjustable key travel that is adjustable by using a rotation-type trigger, a hat-brim-rotation type trigger, or a pry-open-adjustment-type trigger.

### Embodiment I

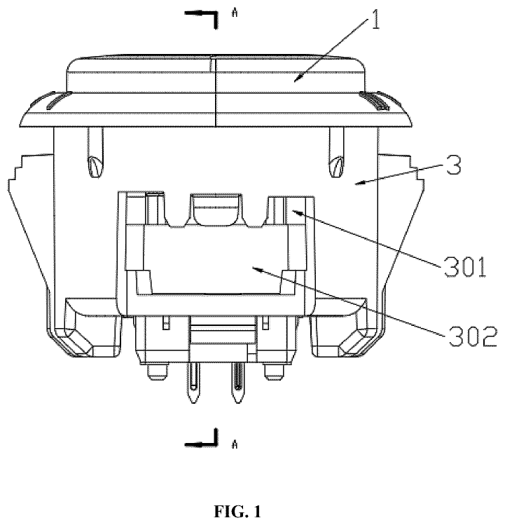

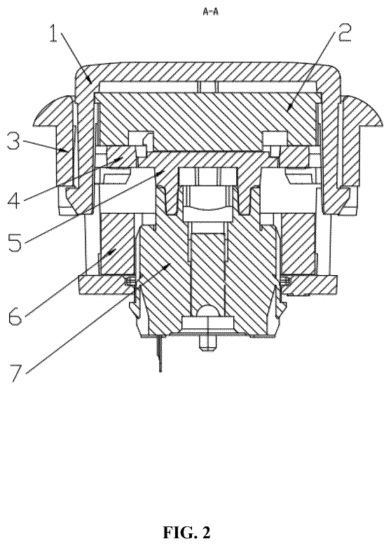

With reference to FIG. 1 to FIG. 8, the present disclosure may provide a switch having an adjustable key travel, including a switch cap 1, silicone member 2, a snap fastener 4, a switch body 3, a micro switch pin member 5, and a silicone pad 6. In one or more embodiments, the silicone member 2 may be a silicone gasket or a silicone pad of the switch cap 1. The switch cap 1 may be clamped to the snap fastener 4, the silicone member 2 may be provided between a body of the switch cap body 101 and the snap fastener 4, and the silicone member 2 may be positioned to connect to the switch cap 1.

The snap fastener 4 may be rotationally connected to the micro switch pin member 5, and the switch cap 1, the silicone member 2 and the snap fastener 4 may form a rotating assembly.

The switch cap 1 may fit a plurality of travel positions 301 on the switch body 3 by means of travel adjusting portions 103, and the switch cap 1 may be pressed and rotated so that the travel adjusting portions 103 may fit different travel positions 301, and then an adjustable key travel is adjusted.

As shown in FIG. 1, three travel positions 301 are illustrated, and heights at where the three travel positions 301 are located may be different. That is, different heights at where each of the plurality of travel positions 301 is located may refer to that its corresponding adjustable key travels may be different from the others.

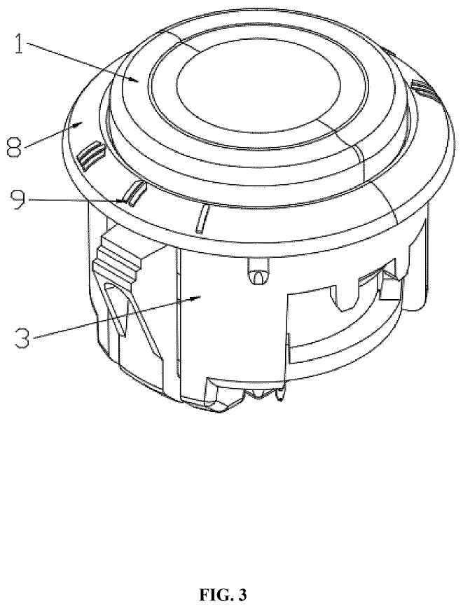

In one or more embodiments of the present disclosure, with reference to a structure of the switch cap 1 shown in FIG. 4, the switch cap 1 includes a body of the switch cap 101. The body of the switch cap 101 may be made from a transparent material, preferably transparent silicone.

The travel adjusting portions 103 and at least one clamping board 102 may be formed on an edge of the body of the switch cap 101. The edge of the body of the switch cap 101 may be provided with positioning grooves 104. A number of the travel adjusting portions 103 symmetrically provided on the edge of the body of the switch cap 101 may be two, and both sides of each travel adjusting portion 103 may be each provided with two clamping boards 102. As a result, it is possible to make the switch cap 1 stably fit the travel position 301 on the switch body 3. The clamping boards 102 may be provided with a clamping hole 106 fitting a clamping bump 401 on the snap fastener 4, and therefore it is possible to make the switch cap 1 stably fit the snap fastener 4.

Furthermore, with reference to FIG. 8, a positioning protrusion 202 is formed on a side edge of the silicone member 2, and the positioning protrusion 202 fits the positioning groove 104.

A compressing portion 201 is provided below the silicone member 2, and the compressing portion 201 may be used to abut against the micro switch pin member 5 connected to the snap fastener 4. The positioning protrusion 202 allows the silicone member 2 to be fitted with the switch cap 1.

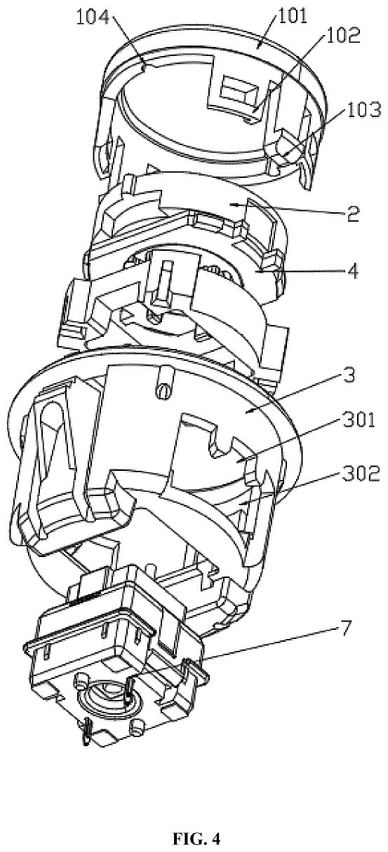

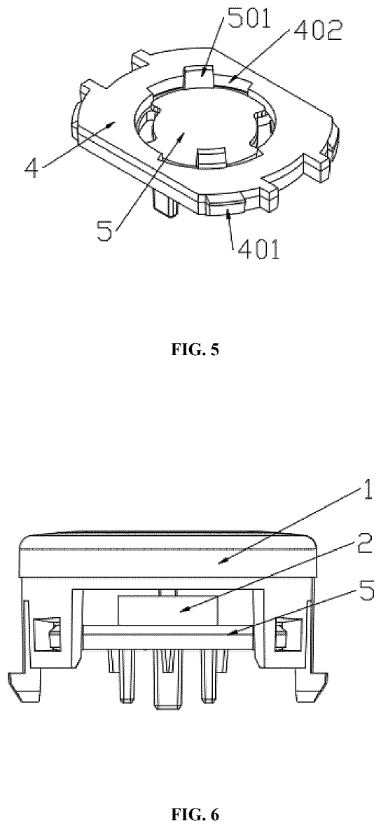

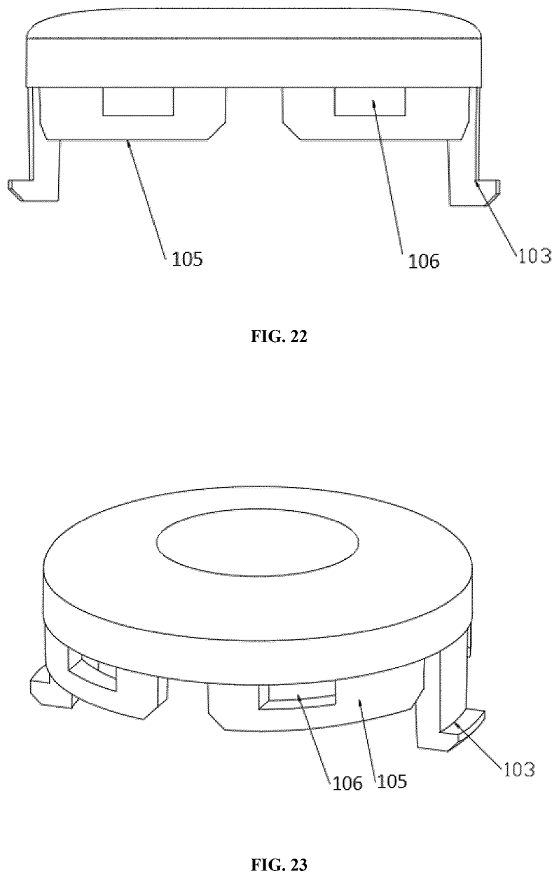

With reference to FIG. 5, the snap fastener 4 includes the clamping bump 401. The clamping bump 401 may be clamped to the clamping hole 106 (shown in FIG. 22) in each of the clamping boards 102 (shown in FIG. 4). By fitting the switch cap 1 with the silicone member 2 and the snap fastener 4, it is possible to form a rotating assembly, and by rotating the rotating assembly, it is possible to adjust the adjustable key travel of the switch.

A mounting hole fitting the micro switch pin member 5 may be formed in the middle of the snap fastener 4, a circumferential side of the mounting hole may be provided with rotating limiting grooves 402, the micro switch pin member 5 may be provided with pin member clamping pins 501, and the pin member clamping pins 501 may fit the rotating limiting grooves 402 and may be able to be rotated relatively to the rotating limiting grooves 402.

In one embodiment, when the switch is in use, the switch cap 1, the silicone member 2, and the snap fastener 4 may be synchronously rotated, a number of the rotating limiting grooves 402 and a number of the clamping pins 501 may each be two, and may be fitted with each other correspondingly. The compressing portion 201 below the silicone member 2 may abut against an upper surface of the micro switch pin member 5, thereby maintaining stability of rotation.

As shown in FIG. 3, an upper edge of the switch body 3 may be provided with gear indicators or gear positions 9 corresponding to different travel positions. In order to facilitate displaying the gear positions 9 for an adjustment of adjustable key travel, the upper edge of the switch body 3 may be provided with a rotary ring 8, the rotary ring 8 may be provided with a plurality of different gear positions 9, and an indication line on the switch cap 1 or the positioning protrusion 202 on the side edge of the silicone member 2 may correspondingly indicate different gear positions 9. In other words, when the indication line on the switch cap 1 is rotated to a corresponding gear position 9 relatively to the switch body 3, at that time it represents that the switch cap 1 is located at a travel position that is corresponding to the corresponding gear position 9.

In one embodiment of the present disclosure, the travel adjusting portion 103 formed on the body of the switch cap 101 may be a clamping pin. The travel positions 301 provided on the switch body 3 may be a plurality of clamping grooves of different heights, and an avoiding groove 302 may be provided below the plurality of clamping grooves. The switch cap is pressed and rotated, and the clamping pin is detached from one of the plurality of clamping grooves to be able to be rotated to a different clamping groove among the plurality of clamping grooves. Preferably, three clamping grooves may be provided and of different heights, and then there are three travel gear positions 9 that the switch may be adjusted to.

Further, the silicone pad 6 may be further provided in the switch body 3, which may be used to improve the hand feeling of the switch.

### Embodiment II

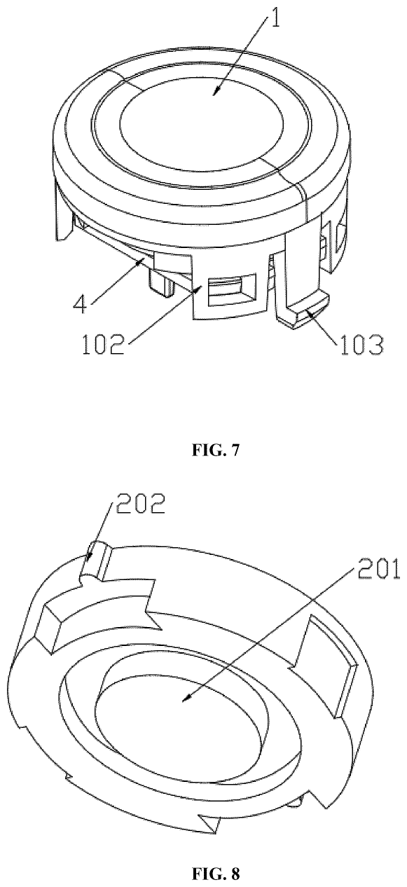

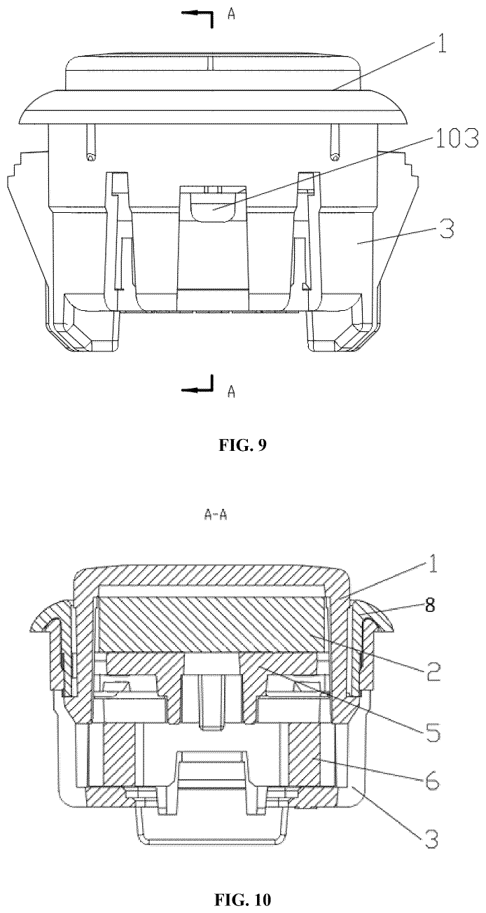

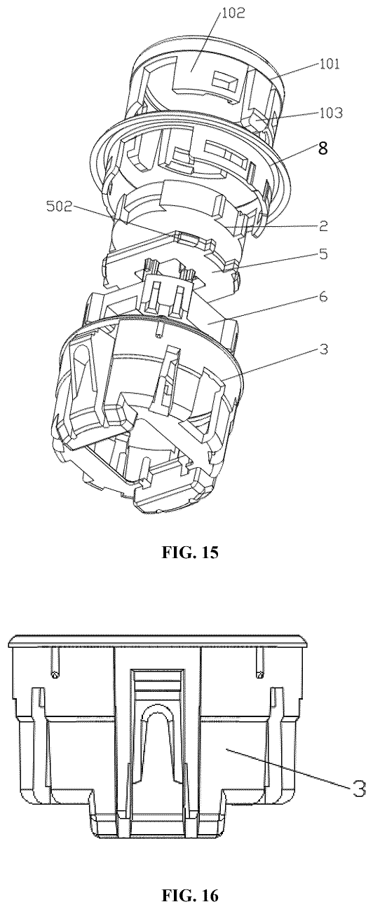

With reference to FIG. 9 to FIG. 17, the present disclosure may further provide a switch having a rotary ring 8 that is rotatable for adjusting the adjustable key travel (hereinafter referred to as an adjustable switch). The adjustable switch may include a switch cap 1, a rotary ring 8, a silicone member 2, a micro switch pin member 5, and a switch body 3. The switch cap 1 may be clamped to the micro switch pin member 5. The silicone member 2 may be provided between the switch cap 1 and the micro switch pin member 5, and the rotary ring 8 may be clamped to the switch body 3 and may be able to be rotated relatively to the switch body 3. A lower edge of the rotary ring 8 may be provided with a plurality of travel positioning edges 113 of different heights, and a number of the plurality of travel positioning edges 113 provided may be two or three, that is, the adjustable switch may provide two or three adjustable key travels. For example, the travel adjusting portion 103 may be positioned to be against a travel positioning edge 113 (e.g., any one of the plurality of travel positioning edges 113) of the plurality of travel positioning edges 113 to determine a corresponding key travel based on a height of the travel positioning edge 113.

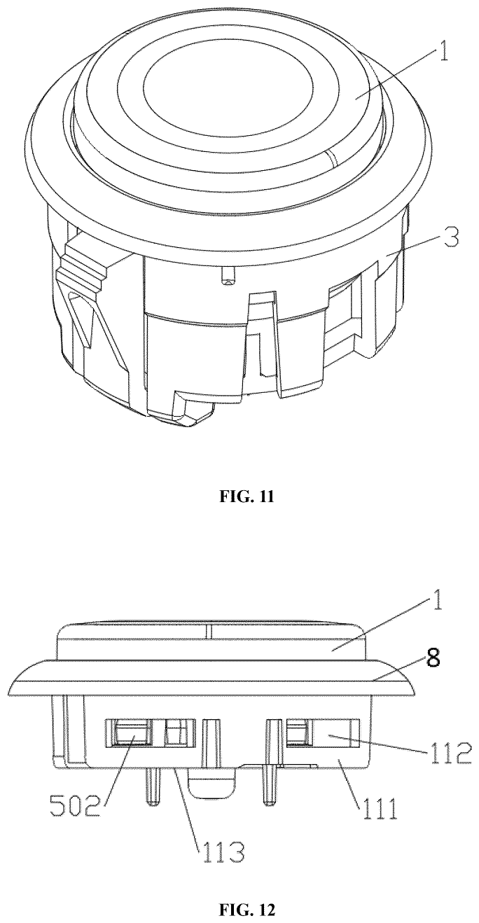

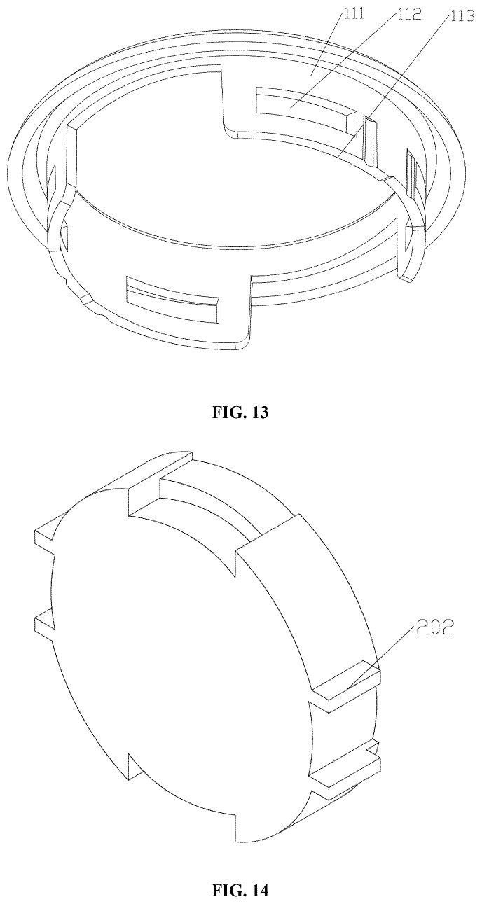

With reference to FIG. 12 or FIG. 13, the lower edge of the rotary ring 8 may be engraved with bottom edges of different heights so as to provide a plurality of different travel positioning edges 113.

The plurality of travel positioning edges 113 of the rotary ring 8 may fit the travel adjusting portion 103 provided on the switch cap 1. By rotating the rotary ring 8, the travel adjusting portion 103 may fit different travel positioning edges 113 to adjust the adjustable key travel. The travel adjusting portion 103 is a positioning clamping pin, and the plurality of travel positioning edges 113 are edges of different heights. In one or more embodiments, the travel positioning edges 113 of different heights may be smoothly connected to each other, whereby it is convenient for the travel adjusting portion 103 (e.g., the positioning clamping pin) to be switched between different travel positioning edges 113.

With the above technical solution, in one or more embodiments, when the adjustable switch of the present disclosure is in use, by rotating the rotary ring 8, the positioning clamping pin of the switch cap 1 is clamped to the lower edge of the rotary ring 8 without being rotated in the circumferential direction. The switch cap 1 may be further clamped to the micro switch pin member 5, and the plurality of travel positioning edges 113 formed by the edges of different heights below the rotary ring 8 may allow switch cap 1 to adjust its height, thereby adjusting the adjustable key travel of the adjustable switch.

In one or more embodiments of the present disclosure, the switch cap 1 may include the body of the switch cap 101, the travel adjusting portion 103, and the clamping boards 102. The travel adjusting portion 103 and the clamping boards 102 may be formed on the lower edge of the body of the switch cap 101. Both sides of the travel adjusting portion 103 are each provided with the clamping boards 102, with a gap between the clamping board 102 and the travel adjusting portion 103. In one embodiment, two travel adjusting portions 103 may be symmetrically provided, which ensures the stability of an adjustment of the adjustable key travel.

Furthermore, with reference to FIG. 14, in one or more embodiments, positioning protrusions 202 may be formed on a side edge of the silicone member 2, and the positioning protrusions 202 may be clamped in the gaps between each of the clamping boards 102 and each of the travel adjusting portions 103, so that the silicone member 2 can be positioned in the circumferential direction. In one or more embodiments, when the switch cap 1 is pressed, the silicone member 2 may provide a rebound effect for the switch cap 1.

In one or more embodiments, limiting protrusions 502 may be formed on a side edge of the micro switch pin member 5, and each of the limiting protrusions 502 may fit a clamping hole formed in the clamping board 102. That is, the micro switch pin member 5 may be fixedly fitted to the switch cap 1.

In one or more embodiments, the micro switch pin member 5 may be fixedly connected to a micro switch 7.

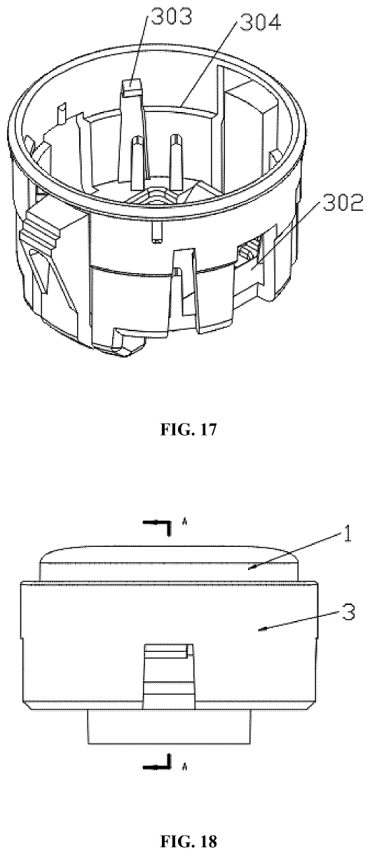

With reference to FIG. 16 and FIG. 17, in one or more embodiments, the switch body 3 may be internally provided with a clamping bump 303 and a supporting step 304, and an outer side face of the switch body 3 may be provided with an avoiding groove 302. The supporting step 304 may be fitted to the travel positioning edge 113 and support the travel positioning edge 113 on the lower edge of the rotary ring 8. The travel adjusting portion 103 on the switch cap 1 may be placed at the avoiding groove 302. The clamping bump 303 may be positioned to fit in and slide within a position adjusting hole 112 formed in the side limiting plate 111, in which the travel positioning edge 113 is located at. In one embodiment, the position adjusting hole 112 may be in a shape of a long strip (with reference to FIG. 12). According to the structure of the embodiment, the switch cap 1 does not rotate when the adjustable switch is in use. By rotating the rotary ring 8 along the supporting step 304, it is possible to adjust the adjustable key travel of the adjustable switch.

In one or more embodiments, the silicone pad 6 may be further mounted in the switch body 3, which improves the hand feeling of the adjustable switch for the user.

### Embodiment III

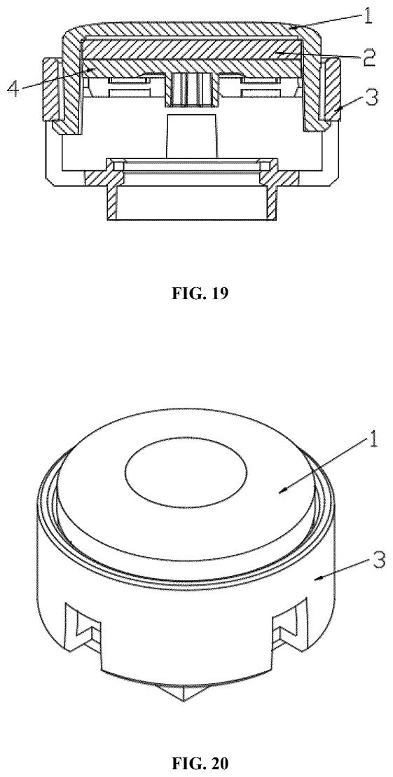

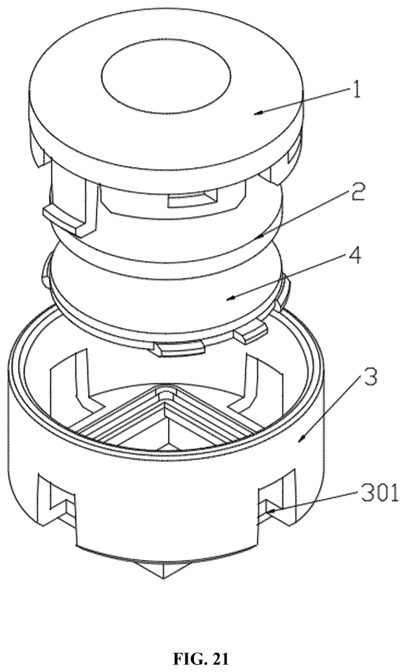

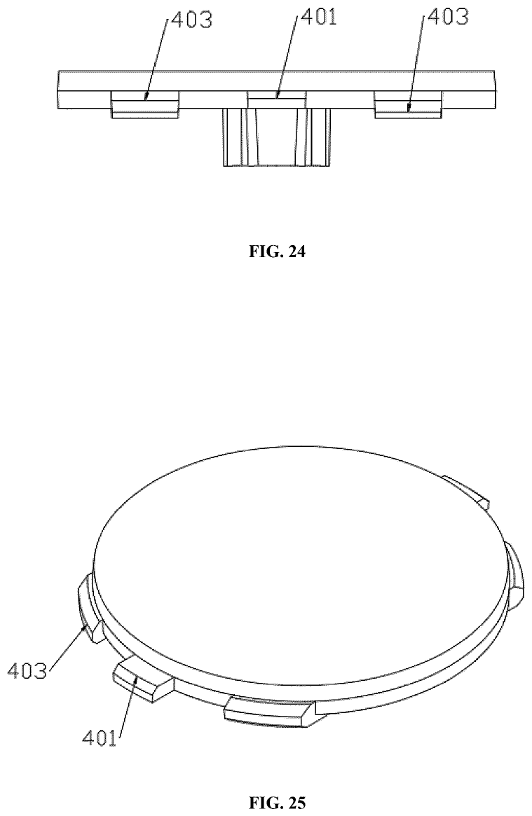

With reference to FIG. 18 to FIG. 25, the present disclosure may further provide a switch having a detachable assembly for adjusting the adjustable key travel (e.g., a pry-open-type switch) (hereinafter referred to as an adjustable switch).

In one or more embodiments, the adjustable switch may include a switch cap 1, a silicone member 2, a snap fastener 4 and a switch body 3. The switch cap 1 may be made from a transparent material. The switch cap 1 may be clamped to the snap fastener 4. The silicone member 2 may be provided between the switch cap 1 and the snap fastener 4.

In one or more embodiments, the snap fastener 4 may be fixedly connected to a micro switch 7.

The switch cap 1 may be provided with at least one travel adjusting portion 103, and the switch body 3 may be provided with a plurality of travel positions 301 of different heights. The travel adjusting portion 103 may fit the travel positions 301 of different heights to adjust the adjustable key travel of the adjustable switch.

In one or more embodiments, when the adjustable switch is in use, the travel adjusting portion 103 of the switch cap 1 may be pried out from a travel position 301 where the adjusting portion 103 is located at. That is, the switch cap 1 is separated from the switch body 3, and then the switch cap 1 is rotated by a certain angle to attach the switch cap 1 back to the switch body 3, such that the travel adjusting portion 103 of the switch cap 1 may fit a different travel position 301 of a different height, so as to adjust the adjustable key travel.

In one or more embodiments, the travel adjusting portions 103 may be positioning clamping pins, the travel positions 301 may be positioning clamping grooves, and the positioning clamping pins may be clamped to/snapped in the positioning clamping grooves.

In one or more embodiments, two types of the positioning clamping grooves of different heights may be provided, a number in each type of positioning clamping grooves may be two, so that four positioning clamping grooves may be provided on the switch body 3 based on an equal angle separation along a circumferential direction of the switch body 3. Furthermore, every two adjacent positioning clamping grooves may be of different heights.

In one or more embodiments, two adjacent positioning clamping grooves may form an angle of 90 degrees. A number of the positioning clamping pin on a side edge of the switch cap 1 may be determined in correspondence with the number of the positioning clamping grooves.

When the adjustable switch is in use, the positioning clamping pins on the switch cap 1 may be pried out from the positioning clamping grooves to separate the switch cap 1 from the switch body 3, and then the switch cap 1 may be rotated by 90 degrees and then inserted into the switch body 3 in order to fit another two positioning clamping grooves. In this case, an adjustment of the adjustable key travel may be achieved by providing two different sets of the positioning clamping pins and the positioning clamping grooves. The structure of the adjustable switch is very simple to operate and is able to meet different needs for different users.

Furthermore, a plurality of side plates 105 may be further formed on the side edge of the switch cap 1, and each of the plurality of side plate 105 may be provided with a clamping hole 106. Positioning bumps 403 and clamping bumps 401 may be formed on a side edge of the snap fastener 4, each of the positioning bumps 403 may be clamped to its corresponding clamping hole 106 provided in the side plate 105, and each of the clamping bumps 401 may be clamped to a gap between two adjacent side plates 105. By means of the structural design of the adjustable switch, a stable fit between the switch cap 1 and the snap fastener 4 can be provided.

In summary, a structure in which the switch cap 1 is clamped to the switch body 3 is used, and the switch body 3 is provided with the travel positions 301 of different heights. When the adjustable switch of the present disclosure is in use, by prying open a fit structure of the travel adjusting portion 103 on the switch cap 1 and the travel position 301 on the switch body 3, and by rotating the switch cap 1 at a certain angle to re-attach the travel adjusting portions 103 to a different travel position 301, the adjustable key travel can be adjusted, so that a response speed of the adjustable switch can be adjusted as well, thereby meeting requirements for the user.

Certainly, the present disclosure is not limited to the above embodiments. The key point of the present disclosure lies in that a distance of the travel adjusting portion of the switch cap from the micro switch in the initial state (a state when the switch is not triggered) can be adjustable, and as to which position or which part of the switch the travel position can be provided is something that a person skilled in the art can derive by a slight transformation according to the inventive concept of the present disclosure without creative labor.

What is described above is only a specific embodiment of the present disclosure, but the protection scope of the present disclosure is not limited thereto, and any person skilled in the art can readily conceive of changes or substitutions within the technical scope disclosed in the present disclosure, all of which shall fall within the protection scope of the present disclosure. Therefore, the protection scope of the present disclosure shall be subject to the appended claims.

What is claimed is:

1. A key travel adjustable switch, comprising:
a micro switch;
a travel positioning member having a plurality of travel positions providing a plurality of key travels; and
a travel adjusting member removably mounted to the travel positioning member,
wherein the travel adjusting member has at least one travel adjusting portion connected to a first travel position of the plurality of travel positions, and the travel adjusting member is triggered to move by a first key travel to trigger the micro switch, and
wherein the first key travel is determined based on the first travel position that the at least one travel adjusting portion is positioned at, and each of the plurality of key travels is different from the others.

2. The key travel adjustable switch according to claim 1, wherein the key travel adjustable switch is a keyboard key, a gamepad switch, or an arcade game switch.

3. The key travel adjustable switch according to claim 1, wherein a number of the plurality of travel positions is from 2 to 10.

4. The key travel adjustable switch according to claim 1, wherein the key travel ranges from 0.1 mm to 3 mm.

5. The key travel adjustable switch according to claim 1, wherein the travel adjusting member is a switch cap, the travel positioning member is a switch body, and the key travel is adjustable by rotating the at least one travel adjusting portion of the switch cap to the different travel positions of the switch body.

6. The key travel adjustable switch according to claim 1, wherein the travel adjusting member is a switch cap, the travel positioning member is a rotary ring, and the key travel is adjustable by rotating the rotary ring to move the at least one travel adjusting portion to the different travel positions of the rotary ring.

7. The key travel adjustable switch according to claim 5, wherein the switch cap is detachably connected to the switch body, and the key travel is adjustable by detaching the switch cap from the switch body, adjusting a direction of the at least one travel adjusting portion of the switch cap, and inserting the switch cap into the switch body.

8. The key travel adjustable switch according to claim 5, further comprising a silicone member, a snap fastener, and a micro switch pin member, wherein the switch cap is clamped to the snap fastener, the silicone member is provided between a body of the switch cap and the snap fastener, and the silicone member is positioned to connect to the switch cap, the snap fastener is rotationally connected to the micro switch pin member, and the switch cap, the silicone member, and the snap fastener form a rotating assembly, wherein the key travel of the key travel adjustable switch is adjustable by fitting the at least one travel adjusting portion at the different travel positions, which is rendered by pressing and rotating the switch cap to fit the at least one travel adjusting portion with the plurality of travel positions on the switch body.

9. The key travel adjustable switch according to claim 6, further comprising a silicone member, a micro switch pin member, and a switch body, wherein the switch cap is clamped to the micro switch pin member, the silicone member is provided between the switch cap and the micro switch pin member, and the rotary ring is clamped to the switch body and is rotated relatively to the switch body, wherein a lower edge of the rotary ring is provided with the plurality of travel positions of different heights, and the at least one travel adjusting portion provided on the switch cap is fitted with the plurality of travel positions, wherein the key travel of the key travel adjustable switch is adjustable by fitting the at least one travel adjusting portion at the different travel positions via rotating the rotary ring.

10. A gaming peripheral, comprising a key travel adjustable switch, wherein the key travel adjustable switch comprises:
a micro switch;
a travel positioning member having a plurality of travel positions providing a plurality of key travels; and
a travel adjusting member removably mounted to the travel positioning member,
wherein the travel adjusting member has at least one travel adjusting portion connected to a first travel position of the plurality of travel positions, and the travel adjusting member is triggered to move by a first key travel to trigger the micro switch, and
wherein the first key travel is determined based on the first travel position that the at least one travel adjusting portion is positioned at, and each of the plurality of key travels is different from the others.

11. The gaming peripheral according to claim 10, wherein the key travel adjustable switch is a keyboard key, a gamepad switch, or an arcade game switch.

12. The gaming peripheral according to claim 10, wherein a number of the plurality of travel positions is from 2 to 10.

13. The gaming peripheral according to claim 10, wherein the key travel ranges from 0.1 mm to 3 mm.

14. The gaming peripheral according to claim 10, wherein the travel adjusting member is a switch cap, the travel positioning member is a switch body, and the key travel is adjustable by rotating the at least one travel adjusting portion of the switch cap to the different travel positions of the switch body.

15. The gaming peripheral according to claim 10, wherein the travel adjusting member is a switch cap, the travel positioning member is a rotary ring, and the key travel is adjustable by rotating the rotary ring to move the at least one travel adjusting portion to the different travel positions of the rotary ring.

16. The gaming peripheral according to claim 14, wherein the switch cap is detachably connected to the switch body, and the key travel is adjustable by detaching the switch cap from the switch body, adjusting a direction of the at least one travel adjusting portion of the switch cap, and inserting the switch cap into the switch body.

17. The gaming peripheral according to claim 14, wherein the key travel adjustable switch further comprises a silicone member, a snap fastener, and a micro switch pin member, wherein the switch cap is clamped to the snap fastener, the silicone member is provided between a body of the switch cap and the snap fastener, and the silicone member is positioned to connect to the switch cap, the snap fastener is rotationally connect to the micro switch pin member, and the switch cap, the silicone member, and the snap fastener form a rotating assembly, wherein the key travel of the switch is adjustable by fitting the at least one travel adjusting portion at the different travel positions, which is rendered by pressing and rotating the switch cap to fit the at least one travel adjusting portion with the plurality of travel positions on the switch body.

18. The gaming peripheral according to claim 15, wherein the switch further comprises a silicone member, a micro switch pin member, and a switch body, wherein the switch cap is clamped to the micro switch pin member, the silicone member is provided between the switch cap and the micro switch pin member, and the rotary ring is clamped to the switch body and is rotated relatively to the switch body, wherein a lower edge of the rotary ring comprises the plurality of travel positions of different heights, and the travel positions fit the at least one travel adjusting portion provided on the switch cap, wherein the key travel of the key travel adjustable switch is adjustable by fitting the at least one travel adjusting portion at the different travel positions via rotating the rotary ring.

19. A method for adjusting a key travel adjustable switch, wherein the key travel adjustable switch comprises:
a micro switch;
a travel positioning member having a plurality of travel positions providing a plurality of key travels; and
a travel adjusting member removably mounted to the travel positioning member, the method comprising:
positioning the at least one travel adjusting portion at a first travel position of the plurality of travel positions;
moving the travel adjusting member by a first key travel to trigger the micro switch, wherein the first key travel is determined based on the first travel position that the at least one travel adjusting portion is positioned at; and
moving the at least one travel adjusting portion to a second travel position of the plurality of travel positions to adjust the first key travel to a second key travel, wherein each of the plurality of key travels is different from the others.

20. The method according to claim 19, wherein the travel adjusting member is detachably connected to the travel positioning member, and the key travel adjustable switch is adjustable by detaching the travel adjusting member from the travel positioning member, adjusting a direction of the at least one travel adjusting portion of the travel adjusting member, and inserting the travel adjusting member into the travel positioning member.
